(19) United States
(12) Patent Application Publication
(10) Pub. No.: US 2025/0320766 A1
(43) Pub. Date: Oct. 16, 2025

(54) PROFILE FRAME SYSTEMS FOR SLIDING ELEMENTS

(71) Applicant: Keller Minimal Windows S.A., Troisvierges (LU)

(72) Inventor: Werner SCHULZEN, Eupen (BE)

(21) Appl. No.: 18/869,946

(22) PCT Filed: Jun. 13, 2023
(86) PCT No.: PCT/EP2023/065841

§ 371 Date: Nov. 27, 2024

(30) Foreign Application Priority Data
Jun. 30, 2022 (LU) LU502 438

(51) Int. Cl. E06B 3/263; E05D 15/06

(52) U.S. Cl. CPC E06B 3/26303; E05D 15/0686; E06B 3/2632; E06B 3/26347; E05Y 2800/278; E05Y 2800/674; E06B 2003/26329; E06B 2003/26352

(57) ABSTRACT

A profile frame system for sliding elements includes a first and second metallic frame profiles, a one-piece insulating support bar made of plastic with a first upper bar plane and a second lower bar plane parallel to the first bar plane. Each bar plane has, on both longitudinal sides, roll-in heads rolled into respective grooves in the first and the second frame profile and thus connect the two frame profiles, wherein in the insulating support bar above the first upper bar plane a snap-in geometry oriented on the longitudinal side is provided, in which a runner is snapped-in. The first upper bar plane is connected to the second lower bar plane with two support struts. These support struts are arranged to diverge from one another at an acute angle α, starting from the snap-in geometry in the first upper bar plane and extending towards the second lower bar plane.

### CROSS-REFERENCE TO RELATED APPLICATIONS

This application is a 35 U.S.C. § 371 National Stage patent application of PCT/EP2023/065841, filed on 13 Jun. 2023, which claims the benefit of Luxembourg patent application 502 438, filed on 30 Jun. 2022, the disclosures of which are incorporated herein by reference in their entirety.

### TECHNICAL FIELD

The present disclosure generally relates to profile frame systems for sliding elements, in particular for sliding doors and sliding windows, as well as to corresponding sliding element profile frames with inserted sliding element.

### BACKGROUND

Numerous composite profile frame systems are known from the prior art. They are preferably made of metal or a metal alloy and can be exposed to adverse weather conditions and strong temperature fluctuations between their inner side and outer side. A high temperature difference between the outer side of the profile frame system, i.e. the one that is arranged outside the building, and the inner side of the profile frame system generally proves to be problematic. To prevent a thermal bridge, two metallic frame profiles (inner and outer profile) are usually connected by a plurality of lesser thermally conductive plastic insulating support bars in such composite profile frame systems.

With profile frame systems suited for sliding elements, this basically simple composite construction is made more difficult by the fact that sliding elements often have heavy multiple glazing as a filling material. However, the forces which are caused by the heavy weight of these multiple glazings, and, of course, increase with the size of the windows and doors, must also be reliably and permanently absorbed by the profile frame system without deforming the construction of the system.

This problem has led to many solutions being proposed, however, what they often have in common is that more or less complex additional metallic support and stiffening profiles are provided in the bond between the frame profiles, which in some cases means that the thermal separation between the outer and inner profiles provided by the insulating support bars can be lost at least partially. These additional measures also generally lead to a greater design height of the composite profiles, all the more so if, for example, in the case of sliding doors, frame elements projecting above the floor are undesired.

### SUMMARY

The present disclosure provides a profile frame system for sliding elements, such as in particular for sliding doors and sliding windows, with heavy sliding-element filling elements, also for large sliding element dimensions, the construction of which does not impair or only insignificantly impairs the thermal separation between the inner and outer profiles and at the same time allows a low design height of the profile frame. Preferably, the profile frame system should not have any components protruding above the floor when the sliding element is open.

According to the disclosure, a profile frame system for sliding elements is provided, in particular for sliding doors and sliding windows, comprising a first metallic frame profile and a second metallic frame profile, a one-piece insulating support bar made of plastic with a first upper bar plane and a second lower bar plane parallel to the first bar plane, wherein each bar plane has, on both longitudinal sides, roll-in heads which are rolled into respective grooves in the first and second frame profile, e.g. hollow chamber profiles made of aluminum, and thus connect both frame profiles, wherein, in the insulating support bar above the first upper bar plane, a snap-in geometry oriented on the longitudinal side is provided, in which a runner is snapped in, wherein the first upper bar plane is connected to the second lower bar plane via two support struts and these support struts are arranged so as to diverge from one another at an acute angle α, starting from the snap-in geometry in the first upper bar plane and extending towards the second lower bar plane.

In contrast to known solutions, the inventors have discovered that even with very heavy multiple glazings, e.g. with sliding elements weighing up to 2000 kg, the resulting forces can be absorbed by a plastic insulating support bar, if a combination of a metal rail and a specifically shaped double insulating support bar or four-headed bar as described above is used. Above all, this can be achieved by using a double insulating support bar whose design height (distance between the first and second bar planes) corresponds to the distance that is quite common between two neighboring single insulating support bars in composite profile frames, namely 2-3 cm. On the other hand, this has the advantage that the design height of a profile frame system according to the disclosure can be kept very low, even if no components (such as the rail) are to protrude beyond the upper edges of the two frame profiles.

Due to the snap-in geometry, the runner can also be attached very easily and without tools, even at the installation site. It would also be possible to replace the runner at a later date without any great effort. Advantageously, the cross-section of the runner and the cross-section of the snap-in geometry are selected such that the runner snaps into the snap-in geometry in a form-fit and force-fit manner. The runner is preferably solid and can be made of any material that makes it possible to distribute the forces caused by the weight of a sliding element moving on it over a sufficient length of the insulating support bar. The runner can be made of e.g. metal, carbon or ceramic, etc. A favorable design of the runner, both technically and economically, is a metal runner with an oval or circular cross-section. It is preferably made of metal, such as stainless steel, but for lighter sliding elements the runner can also be made of aluminum or alloys.

An insulating support bar according to the disclosure thus has at least two bar planes, which are supported by at least two support struts aligned in the longitudinal direction, which form a triangle with the tip turned upwards in the cross-section of the insulating support bar, i.e. the support struts run together upwards at an angle which allows at least some of the forces exerted by the sliding element on the runner, e.g. arranged centrally above the first bar plane, to be transferred laterally to the lower bar plane and thus closer to the lower roll-in heads fastened in the grooves in the first and second frame profiles. Depending on the width and height of the insulating support bar, the angle α between the support struts can be selected differently. Angles α of between 20° and 65°, preferably between 25° and 45° have proven to be very favorable.

The inventors have also discovered that the plastic material and its material thickness need not differ significantly from conventional insulating support bars. In fact, the insulating support bar can be made of plastics commonly used for this application, e.g. (possibly fiber-reinforced) polyamide (PA), polyethylene terephthalate (PET), polybutylene terephthalate (PBT), acrylonitrile butadiene styrene (ABS), polyvinyl chloride (PVC) or mixtures or combinations thereof. The optional fiber reinforcement can be achieved, for example, by adding 5 to 40% by weight, preferably 20 to 35% by weight, of glass fibers to the plastic(s). A particularly preferred material for the insulating support bar is polybutylene terephthalate with approx. 30% glass fibers by weight.

The material thickness of the first upper bar plane, the second lower bar plane and the support struts of the insulating support bar is also in the usual range, e.g. between 1.8 and 3.5 mm, preferably between 2.0 and 2.8 mm, whereby it can be useful to make the support struts of the insulating support bar somewhat stronger (thicker) than the bar planes. Of course, these dimensions do not refer to the material thickness of the roll-in heads as these naturally have a shape that widens towards the end, e.g. a dovetail shape, so that they can be firmly anchored to the frame profiles after having being rolled into the groove.

Another advantage of the insulating support bars according to the disclosure is therefore the fact that, in principle, no new tools need to be purchased, neither for their production nor for their processing in a profile frame system.

As already indicated above, it is often desirable that no components of the profile frame system protrude beyond the upper edge of the first and second frame profile and that a low design height is still possible. This is achieved by arranging the rollers on the sliding element (as described below) and also by the fact that the low design height of the insulating support bar allows it to be arranged between the first and second frame profiles in such a way that the runner is located entirely below the upper edges of the two frame profiles. This also means that the frame of the sliding element is (almost) completely invisible, which is also visually advantageous.

Depending on the design, it can be advantageous that the roll-in heads are offset upwards or downwards in relation to the respective bar plane. This can ensure, for example, that the upper bar plane does not form a shoulder, i.e. a flat surface, after the roll-in heads have been rolled into the corresponding groove in the frame profile. On the upper side, this makes cleaning easier, for example, or on the lower side, the second lower bar plane can, for example, also be better supported on the surface.

Another aspect of the disclosure is a sliding element profile frame with an inserted sliding element, wherein the sliding element profile frame comprises a plurality of profile frame systems surrounding the sliding element and wherein the lower profile frame system (after proper installation), i.e. the profile frame system on which the sliding element rests, is a profile frame system with an insulating support bar and runner as described herein.

The sliding element has a filling element arranged in a frame, preferably multiple glazing or composite filling elements or the like. The sliding element has a number of rollers on the underside of the frame which are distributed along its length so that, in use, they enable the sliding element to be moved by guiding the rollers on the runner. Depending on the width and weight of the sliding element, this number can be larger or smaller; usually the number of rollers is between 2 and 10, preferably between 4 and 6.

The rollers preferably have a groove on their running surface, the shape of which is adapted to the runner and can therefore guide the sliding element securely. Preferably, the runner has an oval or circular cross-section and the rollers have a correspondingly shaped and dimensioned groove in their running surface.

The rollers are attached to the lower frame of the sliding element in a known manner using a roller holder. This is preferably done, for example, with a continuous (one-piece) U-shaped metal or plastic profile, preferably a plastic profile, for all rollers or with individual fastenings for each roller either directly on the frame or by means of a (prefabricated) metal or plastic support profile, preferably a plastic support profile, on the frame.

As already indicated above, the insulating support bar of the profile frame system is preferably arranged between the first and second frame profiles in such a way that the runner is located below the upper edges of the two frame profiles. Even more preferably, the insulating support bar of the profile frame system is preferably arranged between the first and the second frame profiles in such a way that the lower edge of the sliding element is also located below the upper edges of the two frame profiles. Ideally, both the first frame profile and the second frame profile have one or more seals that rest at least in sections against the sliding element or its frame.

### BRIEF DESCRIPTION OF THE FIGURES

Below, embodiments of the disclosure will be described with reference to the accompanying figures. These show:

FIG. 1 a cross-section of an embodiment of a sliding element profile frame with inserted sliding element.

FIG. 2 a perspective view of an embodiment of an insulating support bar for measuring the von Mises stress.

FIG. 3 the result of the force distribution of the von Mises stress in a cross-section of the insulating support bar of FIG. 2.

FIG. 4 the result of the deformation of the von Mises stress in a cross-section of the insulating support bar of FIG. 2.

### DETAILED DESCRIPTION OF THE DRAWINGS

Further details and advantages of the disclosure can be found in the following detailed description of possible embodiments of the disclosure with reference to the accompanying figures.

The embodiment of a sliding element profile frame with a profile frame system 1 and with inserted sliding element 2, shown in FIG. 1, to illustrate the disclosure, will be explained by way of example.

The profile frame system 1, which is used to laterally move a sliding element 2, in particular a sliding door or a sliding window, within a sliding element profile frame, comprises a first frame profile 10 and a second frame profile 20, both e.g. aluminum hollow profiles which are firmly connected by means of a one-piece insulating support bar 30 made of plastic.

This insulating support bar 30 comprises a first upper bar plane 310 and a second lower bar plane 320 parallel to the first bar plane, wherein both bar planes 310, 320 have so-called roll-in heads 315, 325 on their longitudinal sides. The connection between the two frame profiles 10, 20 is achieved by rolling the preferably dovetail-shaped roll-in heads into corresponding grooves in the first and second frame profiles 10, 20 during the manufacture of the profile frame system 1. In addition, the insulating support bar is designed such that the first upper bar plane 310 is connected to the second lower bar plane 320 via two diverging support struts 340, 350. Accordingly, starting from a position below the (usually centrally provided) snap-in geometry 330, these support struts 340, 350 extend from the first upper bar plane 310 diverging at an acute angle α to the second lower bar plane 320. The two support struts 340, 350 thus form an isosceles, acute-angled triangle with a part of the second lower bar plane, the angle of which is a at the apex (between the two isosceles sides, the support struts). In the embodiment shown in FIG. 1, a is approx. 30°; smaller or larger acute angles may also be appropriate depending on the dimensions of the insulating support bar. In general, or if possible, the angle α between 20 and 65° is selected such that the support struts (as close as possible) open into the lateral roll-in heads of the second lower bar plane without, however, hindering the roll-in process when connecting the frame profiles.

In the insulating support bar 30, above the first upper bar plane 310 there is also provided a longitudinally aligned and preferably centrally arranged snap-in geometry 330 for fastening a runner 40, preferably made of metal, carbon or ceramic, such as stainless steel, and having an oval or preferably circular cross-section, wherein fastening is effected by simply snapping the runner 40 positively, preferably non-positively and positively, into the snap-in geometry 330.

On this runner, rollers 70 attached to the sliding element 2 enable lateral movement (‘sliding’) of the sliding element 2 within the sliding element profile frame, of which only the lower part is shown in FIG. 1, which is a profile frame system 1 as described above. At least the lateral parts of the sliding element profile frame can be designed differently from the profile frame system 1, as no runner is required here.

The sliding element mainly consists of a frame 60 and a filling element 50, e.g. a triple glazing as shown in FIG. 1. The aforementioned rollers 70 are attached to the lower side of the frame 60, preferably via a U-shaped metal or plastic profile, preferably a plastic profile, 720 which is either attached directly to the frame 60 or, as shown in FIG. 1, by means of an additional support profile 710 which can, for example, be inserted into a holder provided for this purpose on the frame 60.

Due to the low design height of the insulating support bar 30 it is possible to produce a profile frame system 1 in which the sliding element can be inserted to such an extent that, in the case of a glass filling element, the lower part of the frame does not protrude or hardly protrudes above the floor, thus creating the impression of a frameless window. Expediently, one or more seals 80 are provided on the upper edge of the first metallic frame profile 10 and the second metallic frame profile 20, which lie flush against the sliding element 2 or its frame 60 at least in sections.

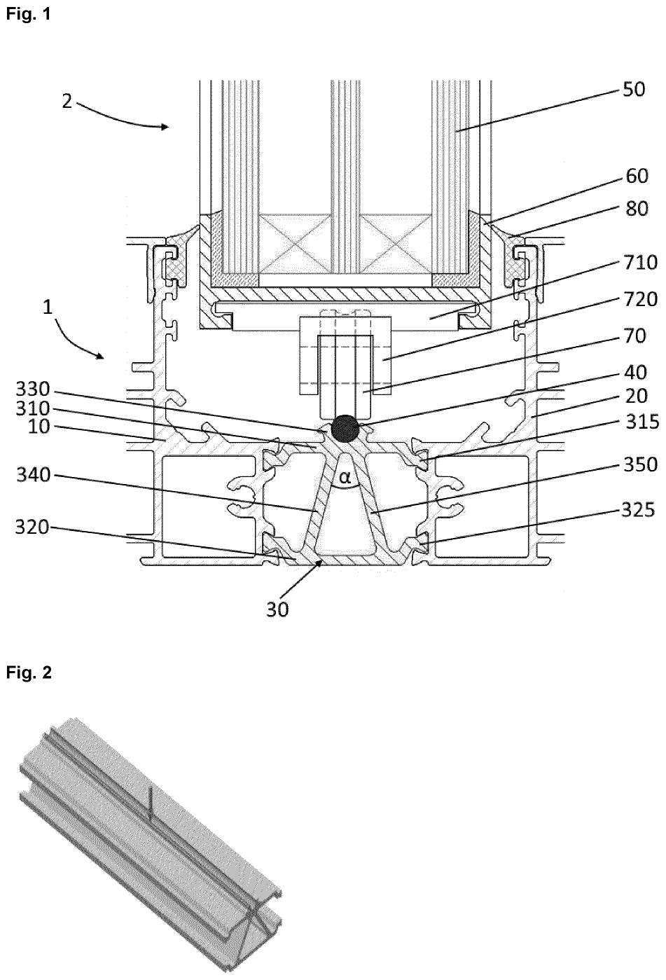

FIG. 2 shows a perspective view of an embodiment of an insulating support bar, as well as the point at which the force is exerted to measure the von Mises stress. The insulating support bar shown here is made of polybutylene terephthalate with a fiber reinforcement of approx. 30% by weight glass fibers. The tested insulating support bar has a total width of 36 mm and a material thickness of 2.5 mm. A force of 1 ton was exerted on the insulating support bar, whereby the worst case was taken into account: the entire load was placed on an insulating support bar with a length of only 200 mm.

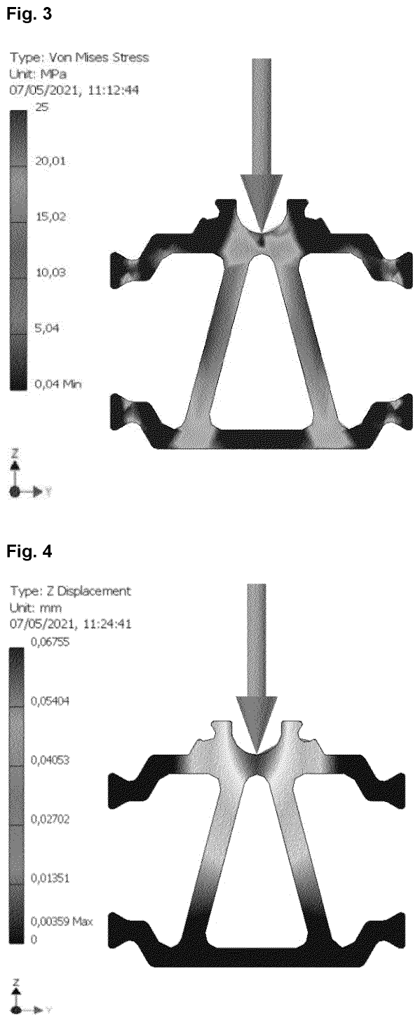

FIG. 3 shows the result of the force distribution of the von Mises stress in a cross-section of the insulating support bar in FIG. 2. As may be seen, the stresses in the support struts of the insulating support bar are at a maximum of around 9-11 MPa. In any case, the stresses acting on the insulating support bar are far away from the tensile strength of polybutylene terephthalate with approx. 30 wt. % glass fibers: 67 MPa.

FIG. 4 shows the result of the deformation of the von Mises stress in a cross-section of the insulating support bar in FIG. 2. Here, too, it can be seen that even with the high load used here, the vertical displacement/deformation of only 0.07 mm is very small.

Therefore, it can be stated that the solution presented here, profile frame system 1 for sliding elements 2 with the insulating support bar 30 described here and the snap-in runner 40 can also realize heavy multi-glazed sliding elements safely and permanently. This is all the more advantageous as it enables a low design height, which in turn also enables apparently frameless sliding elements.

1. A Profile frame system for sliding elements comprising: a first metallic frame profile and a second metallic frame profile, a one-piece insulating support bar made of plastic with a first upper bar plane and a second lower bar plane parallel to the first bar plane, wherein each bar plane has, on both longitudinal sides, roll-in heads which are rolled into respective grooves in the first and second frame profile and thus connect both frame profiles, wherein, in the insulating support bar above the first upper bar plane, a snap-in geometry oriented on the longitudinal side is provided, in which a runner is snapped in, wherein the first upper bar plane is connected to the second lower bar plane via two support struts and these support struts are arranged so as to diverge from one another at an acute angle α, starting from the snap-in geometry in the first upper bar plane and extending towards the second lower bar plane.

2. The profile frame system according to claim 1, wherein the angle α ranges between 20° and 65°.

3. The profile frame system according to claim 1, wherein the runner is positively and non-positively snapped into the snap-in geometry.

4. The profile frame system according to claim 1, wherein the runner is solid and comprises metal, carbon, or ceramic.

5. The profile frame system according to claim 4, wherein the runner has an oval or circular cross-section and is made of metal.

6. The profile frame system according to claim 1, wherein the insulating support bar is arranged between the first and the second frame profile such that the runner is located below the upper edges of the two frame profiles.

7. The profile frame system according to claim 1, wherein the roll-in heads are arranged offset upwards or downwards relative to the respective bar plane.

8. The profile frame system according to claim 1, wherein the insulating support bar comprises a material of polyamide, polyethylene terephthalate, polybutylene terephthalate, acrylonitrile butadiene styrene, polyvinyl chloride or mixtures or combinations thereof.

9. The profile frame system according to claim 1, wherein the material thickness of the first upper bar plane, the second lower bar plane, and the support struts of the insulating support bar ranges between 1.8 and 3.5 mm.

10. The profile frame system according to claim 1, wherein the frame profiles are hollow chamber profiles made of aluminum.

11. A sliding element profile frame with inserted sliding element, wherein the sliding element profile frame comprises several profile frame systems surrounding the sliding element and wherein the lower profile frame system is a profile frame system according to claim 1.

12. The sliding element profile frame with inserted sliding element according to claim 11, wherein the sliding element has a filling element, arranged in a frame, wherein a number of rollers are arranged distributed longitudinally on the underside of the frame such that, in use, the sliding element is displaced by guiding the rollers on the runner.

13. The sliding element profile frame with inserted sliding element according to claim 11, wherein the rollers with a U-shaped profile are attached directly to the frame or by a support profile to the frame.

14. The sliding element profile frame with inserted sliding element according to claim 11, wherein the insulating support bar is arranged between the first and the second frame profile such that the lower edge of the sliding element is located below the upper edges of the two frame profiles.

15. The sliding element profile frame with inserted sliding element according to claim 11, wherein the first frame profile and the second frame profile are provided with one or more seals which abut at least in sections against the sliding element or its frame.
